(19) United States
(12) Patent Application Publication
(10) Pub. No.: US 2005/0274532 A1
(43) Pub. Date: Dec. 15, 2005

(54) Ground improvement device

(76) Inventors: Kevin Lephart, Mequon, WI (US); J. Thomas Jones, Loveland, OH (US); Brian Moore, Georgetown, IN (US)

Correspondence Address: GODFREY & KAHN S.C., 780 NORTH WATER STREET, MILWAUKEE, WI, 53202, US

(21) Appl. No.: 10/858,484

(22) Filed: Jun. 1, 2004

(51) Int. Cl. A01B 33/00

(52) U.S. Cl. 172/410

(57) ABSTRACT

A ground improvement device capable of cultivating, tilling, aerating, or otherwise improving the ground. The ground improvement device has a power source and an axle with at least one tine positioned thereon. A plurality of tines may be positioned on the axle. The number, design, configuration, and location and positioning of the tines may take a variety of forms. In operation, the power source powers the axle to rotate, causing the tine to contact the ground and mix and/or redistribute the soil.

### BACKGROUND OF THE INVENTION

This invention relates generally to an apparatus for improving the ground. In particular, the invention relates to a hand-held apparatus for cultivating, aerating, and mulching soil.

Ground and soil often times must be cultivated in order to grow desired plants. Natural ground conditions and weather can render land difficult for farming, gardening, growing flowers, or maintaining a green lawn. The ground and soil may contain rocks, clay or other materials that hinder the growth of plants. Weather, such as rain, sun, snow, and ice, can, over a relatively short period of time, harden top soil. In addition, top soil may lack sufficient nutrients, aeration, or other properties necessary for optimal plant growth. The result is that much of the available land is unsuitable for easy use.

One method of improving ground quality is to add mulch, such as wood chips, cocoa shells, and lawn clipping, to a planting area. Plants can more easily take root in the mulch. The mulch also protects the soil and ground from weather, erosion, and foot traffic. Still further, mulch generally improves the aesthetics of a given area by presenting a uniform, manicured appearance. However, mulch, much like soil, can be negatively affected by the weather. For example, mulch is subject to becoming compacted or faded. Compaction of mulch, either by weather or foot traffic, results in the mulch becoming interconnected and compressed into a type of “thatched roof.” Compacted mulch restricts the amount of water reaching roots located below the mulch. Faded mulch is unsightly and detracts from the well-manicured and healthy look normally associated with mulch. In addition, fungus, bacteria, insects, weeds and other organisms can grow in unattended mulch.

As such, it is highly desirable to cultivate, aerate, and redistribute ground, soil, and mulch. Many devices have been designed to facilitate improving the ground. One such device is a standard ground rake. A user runs the rake over an area, mixing the top soil or mulch with the next stratus of material. Another such device is a hoe. A user uses the hoe to overturn soil or mulch and to aerate the ground. Such devices require exertion of a large amount of effort by the users to effectively improve the ground.

Another type of device is a variation on a rake or hoe. This device, commonly known as the Garden-Weasel®, has an extended handle connected to a forked end. A series of blades are connected to the forked end. The blades are able to rotate. A user runs this device over an area, thereby causing the blades to rotate. The rotatable blades allow the Garden-Weasel® to mix soil better than a standard rake or hoe. The Garden-Weasel®, however, requires significant effort to operate. This device is limited in the types of material with which it can be used. Dry or tough material cannot be easily mixed or de-thatched using the Garden-Weasel®.

Another type of device is a powered, wheeled device similar in appearance to a lawn mower. Instead of a blade, this type of device has a series of spikes. The spikes cultivate the ground as the device is wheeled around a yard or garden. Such devices are disclosed in U.S. Pat. No. 2,998,690 to Ferris, U.S. Pat. No. 3,439,747 to Kindlien et al., and U.S. Pat. No. 3,878,899 to Jones. Other types of ground improvement devices include rototillers and min-cultivators. All these types of devices are relatively large, have wheels which can hurt or destroy vegetation, and are considerably expensive to manufacture. In addition, these devices dig deeply into the ground and tend to distribute material directly behind the machine.

The current ground improvement devices suffer from certain drawbacks and limitations. Accordingly, a need exists for a ground improvement device that is easily transportable, relatively inexpensive to manufacture, relatively compact, and solves other problems associated with the existing ground improvement devices.

### SUMMARY OF THE INVENTION

The present invention provides for a ground improvement device capable of cultivating, tilling, aerating, or otherwise improving the ground. The ground improvement device is a hand-held device that preferably has a shaft with a motor and an axle. The axle has a plurality of tines positioned thereon. The motor causes the axle, and thereby the tines, to rotate. The axle rotates in a plane substantially parallel to the ground. In operation, the device is placed on the ground on an area to be improved. The power is activated, which causes the axle to rotate thereby causing the tines to dig into and improve the ground.

In one embodiment, the axle has a first set of tines and a second set of tines positioned thereon. The first set of tines may be positioned on the axle substantially perpendicular to the second set of tines. Also, the first and/or second set of tines may alternate having long and short portions extending from the axle in a given direction. Further, the first set and second set of tines may alternate on the axle.

In one embodiment, the axle has a plurality of pieces with at least two pieces connected a gear box, which is in turn connected to the motor. In one embodiment, at least one extension is attached to the axle. The extension may have tines or other features or structures.

### DESCRIPTION OF THE DRAWINGS

FIG. 1 is a perspective view of a ground improvement device in accordance with one embodiment of the present invention;

FIG. 2 is a perspective view of a portion of the ground improvement device of FIG. 1;

FIG. 3 is a side view of a portion of the ground improvement device of FIG. 1;

FIG. 4 is a front view of a portion of the ground improvement device of FIG. 1;

FIG. 5 is a partially exploded view of a ground improvement device in accordance with one embodiment of the present invention;

FIG. 6 is a perspective view of a portion of a ground improvement device in accordance with one embodiment of the present invention;

FIG. 7 is a perspective view of a portion of a ground improvement device in accordance with one embodiment of the present invention;

FIG. 8 is a perspective view of a portion of a ground improvement device in accordance with one embodiment of the present invention; and,

FIG. 9 is a perspective view of a portion of a ground improvement device in accordance with one embodiment of the present invention.

### DETAILED DESCRIPTION OF THE PREFERRED EMBODIMENTS

The ground improvement device 30 of the present invention is capable of cultivating, tilling, aerating, or otherwise improving the ground. The ground improvement device 30 has a power source 34 and an axle 38 with tines 40 positioned thereon. In operation, the power source 34 powers the axle 38 causing it to rotate and when deployed on the ground, causing the tines 40 to dig into and improve the ground.

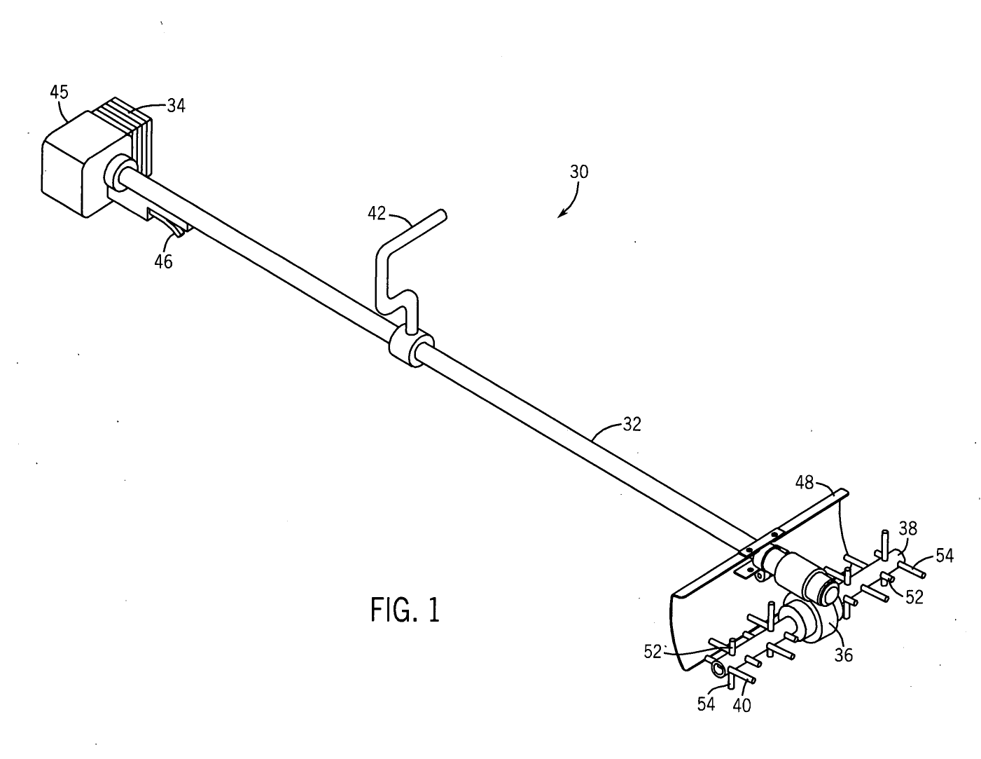

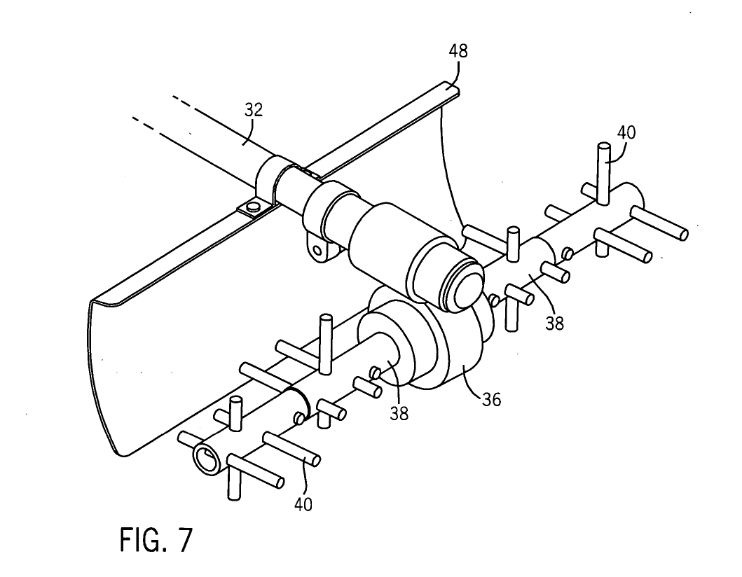

As shown in FIGS. 1-9, the ground improvement device 30 has a shaft 32. At least one axle 38 and a power source 34 are connected to the shaft 32. The axle 38 is preferably rotatably connected to the shaft 32 via a motor 36. The motor 36 may be any device capable of rotating the axle 38 or translating energy from the power source 34 into rotation of the axle 38.

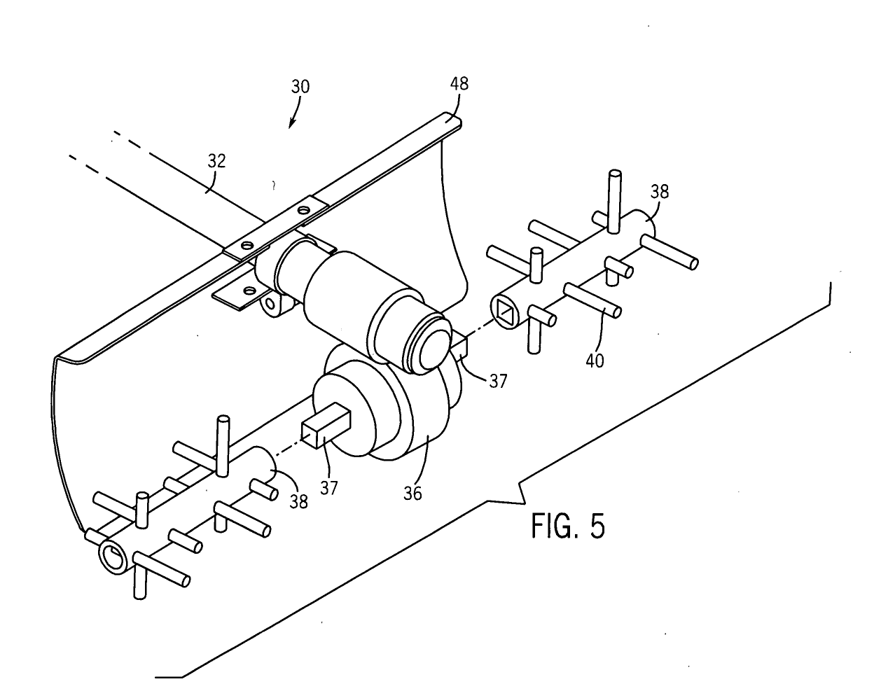

The axle 38 is functionally engaged with the motor 36. In one embodiment of the present invention shown in FIG. 1, the axle 38 is inserted through the motor 36. In another embodiment shown in FIG. 5, the axle 38 is simply attached to the motor 36 and preferably to a driver 37 of the motor 36.

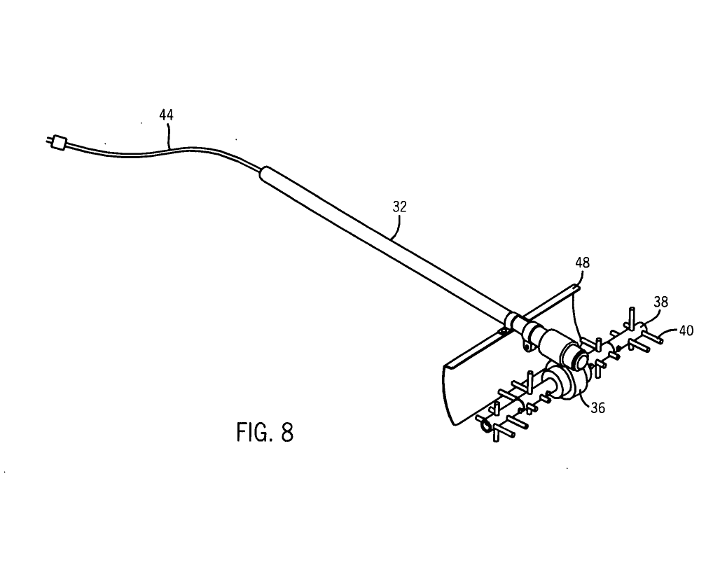

As shown in FIG. 1, a motor 36 is positioned at the end of the handle. The motor 36 is powered by a power source 34 located at the other end of the handle. In one embodiment, shown in FIG. 1, the power source 34 is a battery. In another embodiment, shown in FIG. 8, the power source is standard household power transmitted to the motor 45 via a cord 44. Regardless of the power source, the rotation of the axle 38 is preferably controlled by a trigger 46. As shown in FIG. 1, depressing the trigger 46 results in the rotation of axle 38. Releasing the trigger 46 results in the cessation of rotation of the axle 38. Of course, the ground improvement device 30 may be equipped with a device to prevent inadvertent operation of and/or disruption of power to the axle 38.

Alternatively, a motor may be positioned at the top of the handle. In such case, a rod extends down the shaft 32 and engages a gear system such as a worm gear box. The motor causes the rod to rotate while the gear system translates the axial rotation of the rod into rotation of the axle 38 and thus movement of the tines 40. The motor may be any type of motor, such as an electric or gasoline motor.

The motor 36 preferably rotates the axle 38, at a low rate of rotations per minute (RPM). The axle 38 is rotated between about 100 to 650 RPM and most preferably between about 200 to 400 RPM. The relatively slow RPM of the axle serve to break-up and evenly distribute soil, mulch, and the like.

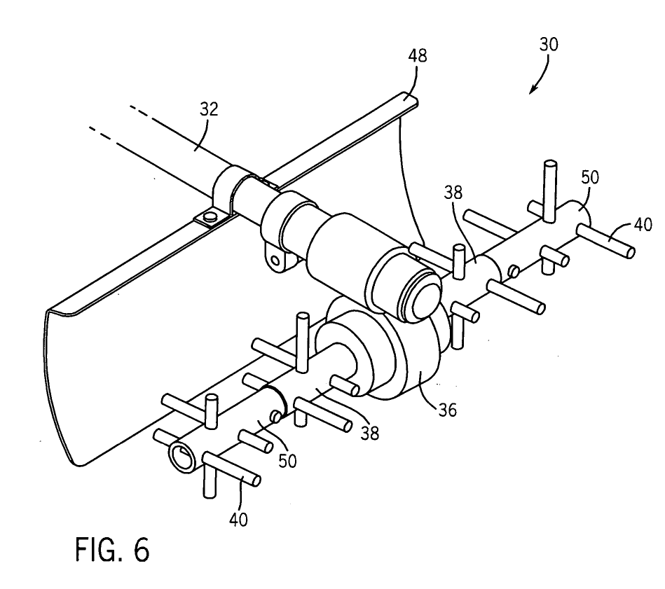

Most preferably as shown in FIG. 3, the axle 38 is rotated so that the tines 40 travel axially in direction D. However, the axle could be rotated axially in either or both directions. In one embodiment, the axle 38 is a single piece attached to a driver 37. In another embodiment shown in FIG. 5, the axle 38 is a plurality of parts with at least one part attached to a driver 37 on either side of the motor 36. Preferably, the axle is about 1 inch in diameter. As shown in FIGS. 6-8, the axle 38 may include at least one extension 50 attached to an end of the axle 38. The extensions 50 may have a single or plurality of tines 40 and/or other features such as an edger, blade, wheel, or the like positioned thereon. The tines 40 on the extension may be positioned and configured as described with respect to the tines 40 positioned on the axle 38.

The extensions 50 allow a user to vary the functional length of the axle 38 depending on the size of an area to be improved. For example, a user may wish to use the device 30 to improve a rather large area of ground without any encumbrances such as trees or the like. Such a user could attach extensions 50 with tines 40 to the axle 38. The extensions 50 allow the user to improve a larger area and thus increase efficiency. Likewise, a user improving a smaller area or an area with encumbrances may remove the extensions 50, thereby making the device 30 more maneuverable and less likely to damage existing vegetation.

Preferably, the tines 40 are removably attached to the axle 38, thereby allowing tines 40 to be replaced as desired. For example, a tine 40 may be replaced if broken or worn. A tine 40 may also be replaced with a tine 40 of a different design to provide desired functionality. In one embodiment, the position of the tines 40 relative to the axle 38 is selectable. For example, the length of the tines 40 extending from the axle 38 may be altered as desired. Preferably, the tines 40 are inserted through the axle 38. In another embodiment, the tines 40 are permanently attached to the axle 38 by welding, adhesive, glue, bolt, screw, or the like.

The tines 40 may have a variety of designs, shapes, and sizes. The tines 40 positioned along the axle 38 may be the same design, have different designs, or any combination thereof. Preferably, as shown in FIGS. 1-9, the tines 40 all have the same relative rod like shape with a round cross-section. The tines 40 may have additional structures attached thereto. For example, the tines 40 may have a blade attached thereto to cut through soil, mulch, or vegetation. The tines 40 may also be coated with any number of compositions. For example, the tines 40 may be coated with pesticide, herbicide, and/or other composition to kill, prevent, or inhibit undesirable organisms, such as aphids and weeds, from living in the ground or plants rooted therein. The tines 40 may also be coated with a composition, such as a lubricant, to facilitate passage through hardened or rocky ground. The tines 40 may also be coated with a composition, such as a rust-proofing agent or sealant, to extend the lifetime of the tines 40.

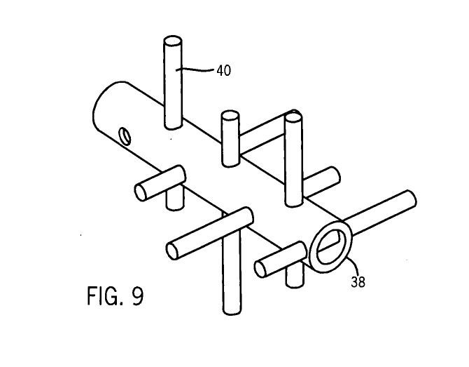

In embodiments without an extension 50, 7 or 8 tines 40 are preferably positioned on the axle 38 on each side of the motor 36. In embodiments utilizing an extension 50, each side of the motor 36 preferably has 3 or 4 tines 40 are positioned on the axle and 3 or 4 tines positioned on the extension 50. Preferably, as shown in FIG. 9, the tines 40 positioned along the axle 40 alternate in alignment so that each tine 40 is substantially perpendicular to the next tine 40. In one embodiment, the tines 40 are inserted through the axle 38 and extend about the same amount on either side of the axle 38. Preferably, however, as shown in FIGS. 1-9, the tines 40 extend further on one side of the axle 38 so that at least one tine 40 has a short portion 52 and a long portion 54. As shown in FIGS. 1-8, the position of the tines 40 alternate so that a long portion 54 of one tine 40 is positioned next to the short portion 52 of another tine 40.

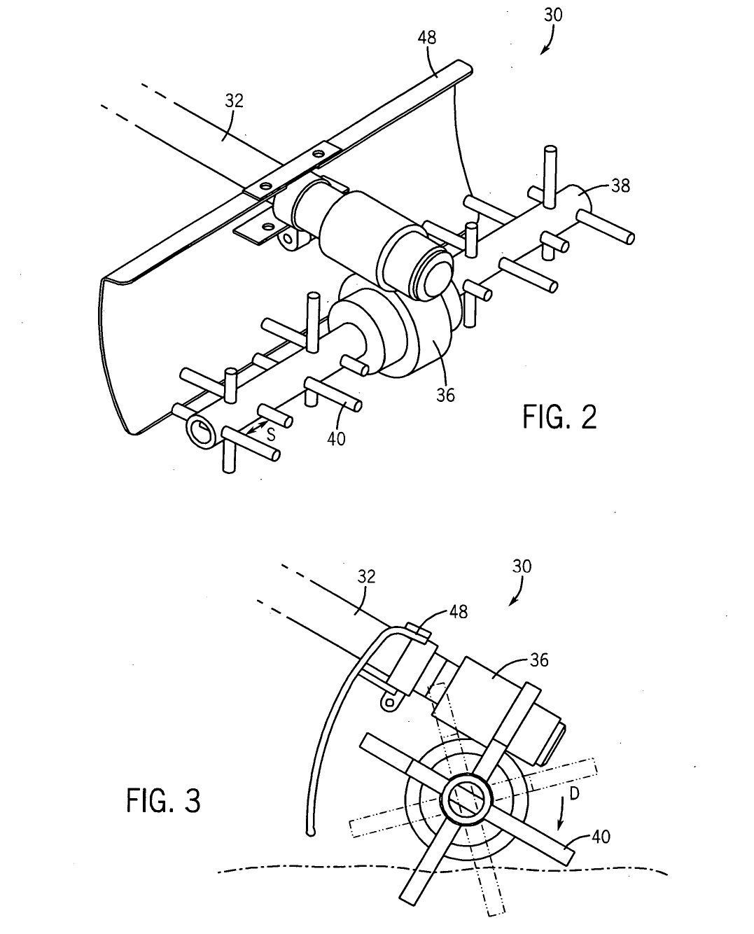

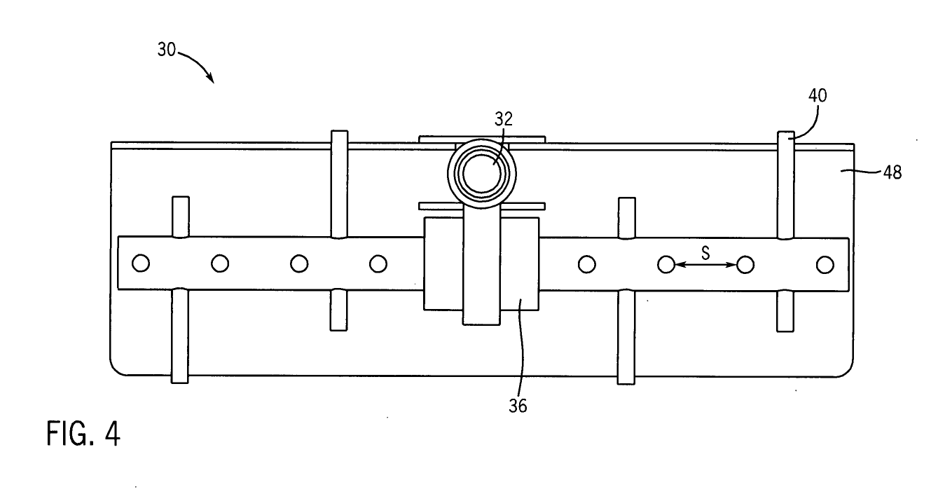

The tines 40 may be spaced apart from one another at any distance. In one embodiment, the tines 40 are about evenly spaced along the axle 38. Preferably, the tines 40 are spaced about 0.5 to 1.0 inches, and most preferably about 0.75 inches, from the next tine 40 with the first tine 40 spaced about 1 inch from the motor 36. In one embodiment shown in FIGS. 2 and 4, the tines 40 positioned at one angle are spaced a distance S (about 1.5 inches) apart.

Preferably, the ground improvement device 30 of the present invention includes certain safety and other useability features. Such features include a shield 48 positioned near the axle 38. The shield 48 helps prevent rocks, dirt, and other debris from hitting a user or from being expelled from the ground improvement device 30. The shield 48 also helps evenly redistribute loosened ground. Another feature is a handle 42 positioned on the shaft 42. The handle 42 assists the user in controlling and using the ground improvement device.

In one embodiment, the ground improvement device 30 is hand-held like a powered trimming device. In another embodiment, the ground improvement device 30 is equipped with at least one wheel and at least partially rests on the wheel when in use.

The ground improvement device of the present invention may have other applications aside from use in connection with improving the ground. Further, the invention may be implemented in a variety of configurations, using certain features or aspects of the several embodiments described herein and others known in the art. Thus, although the invention has been herein shown and described in what is perceived to be the most practical and preferred embodiments, it is to be understood that the invention is not intended to be limited to the specific features and embodiments set forth above. Rather, it is recognized that modifications may be made by one of skill in the art of the invention without departing from the spirit or intent of the invention and, therefore, the invention is to be taken as including all reasonable equivalents to the subject matter of the claims.

1. A hand-held ground improvement device comprising:
a power source;
a motor connected to the power source, wherein the motor is connected to a shaft; and,
at least one axle rotatably engaged by the motor, the axle having a plurality of tines positioned thereon, wherein said axle lies in a plane substantially parallel to the ground when the device engages the ground and wherein said axle is rotated so as to selectively bring each of said plurality of tines into contact with the ground on a periodic basis.

2. The ground improvement device of claim 1 further comprising a shield positioned on the shaft.

3. The ground improvement device of claim 1 wherein at least one tine is positioned on the axle at an angle relative to another tine.

4. The ground improvement device of claim 3 wherein at least one time is positioned on the axle at an angle substantially perpendicular to another tine.

5. The ground improvement device of claim 4 wherein each tine is positioned on the axle at an angle substantially perpendicular to a next tine.

6. The ground improvement device of claim 1 wherein at least one tine is positioned on the axle so that the tine has a short portion and a long portion such that the short portion extends in one direction from the axle and a long portion extends in an opposite direction from the axle.

7. The ground improvement device of claim 1 wherein the tines are positioned on the axle in an alternating pattern, the tine alternating between having a short portion extending in one direction from the axle and a long portion extending in an opposite direction from the axle and vice versa.

8. The ground improvement device of claim 1 further comprising a first set of tines and a second set of tines positioned on the axle.

9. The ground improvement device of claim 8 wherein the first set of tines is positioned substantially perpendicular to the second set of tine.

10. The ground improvement device of claim 8 wherein the first set of tines comprises tines that alternate between having a short portion extending in one direction from the axle and a long portion extending in an opposite direction from the axle and vice versa.

11. The ground improvement device of claim 8 wherein the second set of tines comprises tines that alternate between having a short portion extending in one direction from the axle and a long portion extending in an opposite direction from the axle and vice versa.

12. The ground improvement device of claim 8 wherein the first set of tines and the second set of tines alternate along the axle.

13. The ground improvement device of claim 1 wherein said axle comprises a plurality of pieces, with at least two pieces connected to the motor.

14. The ground improvement device of claim 1 further comprising at least one extension attached to said axle.

15. The ground improvement device of claim 1 wherein the device is substantially supported by only a user and the ground when in use, without the use of wheels.

16. The ground improvement device of claim 1 wherein the device does not have any wheels.

17. A hand-held ground improvement device comprising:
a power source;
a motor connected to the power source, wherein the motor is connected to a shaft;
a shield connected to the shaft; and,
at least one axle rotatably engaged by the motor, the axle having a first set of tines and second set of tines positioned thereon, wherein said axle lies in a plane substantially parallel to the ground when the device engages the ground, wherein said axle is rotated so as to selectively bring each said plurality of tines into contact with the ground on a periodic basis and the device is substantially supported on the ground by the tines.

18. The ground improvement device of claim 17 wherein the first set of tines is positioned on the axle substantially perpendicularly to the second set of tines.

19. The ground improvement device of claim 17 wherein the first set of tines comprises tines that alternate between having a short portion extending in one direction from the axle and a long portion extending in an opposite direction from the axle and vice versa.

20. The ground improvement device of claim 17 wherein the second set has a plurality of tines that alternate between having a short portion extending in one direction from the axle and a long portion extending in an opposite direction from the axle and vice versa.

21. The ground improvement device of claim 17 wherein tines of the first set of tines and the tines second set of tines alternate along the axle.

22. The ground improvement device of claim 17 wherein:
the first set of tines is positioned on the axle substantially perpendicularly to the second set of tines;
the tines of the first set of tines alternate between having a short portion extending in one direction from the axle and a long portion extending in an opposite direction from the axle and vice versa; and,
the tines of the second set of tines alternate between having a short portion extending in one direction from the axle and a long portion extending in an opposite direction from the axle and vice versa.

23. The ground improvement device of claim 22 wherein the first set of tines and the second set of tines alternate along the axis.

24. A ground improvement device comprising:
a power source;
a motor connected to the power source, wherein the motor is connected to a shaft;
at least one axle rotatably engaged by the motor, the axle having a plurality of tines positioned thereon, wherein said axle lies in a plane substantially parallel to the ground when the device engages the ground and wherein said axle is rotated so as to selectively bring each said plurality of tines into contact with the ground on a periodic basis; and,
at least one extension selectively attachable to said axle.

25. The ground improvement device of claim 24 further comprising a first set of tines and a second set of tines.

26. The ground improvement device of claim 24 wherein the first set of tines is positioned on the axle about perpendicular to the second set of tines.

27. The ground improvement device of claim 26 wherein:
the first set of tines comprises tines that alternate between having a short portion extending in one direction from the axle and a long portion extending in an opposite direction from the axle and vice versa; and,
the second set of tines comprises tines that alternate between having a short portion extending in one direction from the axle and a long portion extending in an opposite direction from the axle and vice versa.
